(19) United States
(12) Patent Application Publication
(10) Pub. No.: US 2021/0398500 A1
(43) Pub. Date: Dec. 23, 2021

(54) OPERATING CIRCUIT FOR LC DEVICE

(71) Applicant: CAMBRIDGE ENTERPRISE LIMITED, Cambridge Cambridgeshire (GB)

(72) Inventors: Daping CHU, Cambridge Cambridgeshire (GB); John MOORE, Cambridge Cambridgeshire (GB)

(21) Appl. No.: 17/292,079

(22) PCT Filed: Nov. 8, 2019
(86) PCT No.: PCT/GB2019/053174

§ 371 Date: May 7, 2021

(30) Foreign Application Priority Data
Nov. 8, 2018 (GB) 1818187.5

(51) Int. Cl. G09G 3/36; G02F 1/133; G02F 1/137; H02M 7/217; H02M 1/08

(52) U.S. Cl. CPC G09G 3/3651; G02F 1/13306; G02F 1/13756; G09G 2300/0473; H02M 1/083; G09G 2330/02; H02M 7/217

(57) ABSTRACT

The present disclosure relates to an operating circuit suitable for operating a liquid crystal device, the circuit including a means for supplying unsmoothed DC from an AC source to a switching circuit, wherein the switching circuit has an output, and means for operating the switching circuit to provide at least two alternative frequencies at the output.

### FIELD OF THE INVENTION

The present disclosure relates in general terms to the field of circuitry. The inventors envisaged the main field of application as being to liquid crystal (LC) devices, and more particularly but not exclusively to Smectic-A LC (SmA LC) devices. However, some embodiments of the disclosure may be applied to other loads that require supply at two (or more) frequencies.

### BACKGROUND OF THE INVENTION

In the LC application, some types of liquid crystal, (for instance SmA LC) can be set into a stable scattered or partially-scattered state by being driven by a low frequency alternating waveform, and cleared or partially-cleared by being driven with a higher frequency alternating waveform. When the waveforms are removed, the material remains in its scattered or cleared state. The applied waveforms are de-balanced (i.e. have no residual DC offset) to maintain liquid crystal lifetime. Typical frequencies are 20-100 Hz for scattering and 200 Hz-4 kHz for clearing, although different physical properties, such as thickness, or temperature and different formulations may require different frequencies.

SmA LC panels and devices have a number of diverse applications, and there are a number of challenges. Some of these are application-specific, or specific to nature or location of use. Some are more general.

Although reliability is clearly desirable in all applications, it will be appreciated that where a component is incorporated in a building structure, or is applied to a building as a façade or as a display, it becomes crucial. A typical requirement is for a lifetime of at least 20 years.

Applications involving buildings include use as an active façade, selectively obscuring a relatively large area of the building. For example, this may enable the sun's rays to be screened from the inside of that part of the building, or thereby enabling enhanced security to an activity in that part of the building, or selectively obscuring small panels as display elements, thereby enabling information to be displayed to people inside or outside of the building. Functionality provided in the building context includes modulating or controlling light, privacy and security both from outside or from space to space within the building, providing ambient change and information display.

In so-called “green” buildings, the need for air conditioning as a result of solar gain may be reduced or eliminated by applying SmA LC panels to the building cladding, or incorporation of such panels into windows.

SmA LC panels may be used in standalone information displays, including for example, advertising hoardings, displays of road traffic information and many other fields, both colour or monochrome. Current fields that are envisaged include a) public information displays, for traffic signs, vehicle/train banners, roadside notices, motorway information panels, non-intrusive information displays for airport/train station/hospital/other public places, b) private information displays, for in-room/in-house non-intrusive/non-emissive low energy displays, including information (weather, time, etc) and indicators for household appliances; and c) high resolution displays, e.g. e-book types.

SmA LC panels or devices may be applied in many other fields, for example motor vehicles (windows/sunroofs), aeroplanes (windows/partitions), public areas (privacy partitions), bank counters (security measure), data centres (security).

There is also a class of “outdoor” applications where users or the public may come into contact with the SmA LC panels or devices, and especially some portable device applications where not only reliability but protection from electric shock is highly important. For example, polytunnel-type plant housings for horticulture/agriculture (for instance allowing shading to be applied in high sunlight conditions) and so-called gazebo or marquee structures for outdoor events benefit from the use of SmA LC technology, for light screening, privacy or information display. Control of plant growth structures or outdoor event housings incorporating SmA LC devices may be such as to respond automatically to ambient conditions, or to respond to control inputs. Outdoor applications may present electrical safety problems, for example, to installers and users, especially where residual charge is present on the panel/device.

On the other hand, the fact that no active powering of the panel or device is necessary means that state changes can be made in a short period, and then the device left electrically floating provides greater safety than permanently-powered devices.

Many of the applications of SmA LC panels and devices are in locations where there is a “mains” supply, i.e. a readily available supply having a frequency adapted to provide scattering of SmA LC material. In some cases, this will be a true mains, available from a mains supply system and having a regulated frequency of, say, 50 Hz or 60 Hz. In other cases, this scattering frequency may be generated specifically for the SmA LC device. The term “generated” is not intended to be restrictive and does not necessarily imply electromagnetic machines.

Previous drivers of which the inventors are aware have required de power supplies and operate by chopping the DC to produce square wave alternating voltages. Some use direct drive from 50 or 60 Hz transformed mains voltage, or use resonant circuits to produce a higher frequency sine wave, typically over 200 Hz. These drivers may be complex electronically to switch between waveforms. They may require high DC voltage supplies. They may also require relatively large capacitors, for example, electrolytic smoothing capacitors and large heavy power transformers.

Embodiments of the invention aim to improve over state of the art devices.

Embodiments of the present invention may be formed to consist of simple circuitry, using unsmoothed DC to provide high reliability, low costs, easy assembling and compact size.

Lightweight and easily portable embodiments can be made that have no power transformer.

The ability to create embodiments having no large capacitors can prevent after-shocks to users or installers. Embodiments without electrolytic capacitors can provide improved reliability.

### SUMMARY OF INVENTION

In one aspect, there is disclosed an operating circuit suitable for operating a liquid crystal device, the circuit having means for supplying unsmoothed DC from an AC source to a switching circuit, wherein the switching circuit has an output, and means for operating the switching circuit to provide at least two alternative frequencies at the output.

The unsmoothed DC may be derived from a mains transformer, so that the ripple rate is 50 or 60 Hz, or 100 or 120 Hz. It may be derived from an inverter. It may be derived directly from the mains via a rectifier, or via an impedance such as a capacitive or resistive divider and a rectifier arrangement.

The switching circuit may be a bridge, and the bridge may use plural FETs.

The means for operating may include one or more opto-isolators. The means for operating the switch circuit may comprise one or more transformers.

The switching circuit may alternatively use bipolar transistors.

One of the alternative frequencies may be the mains frequency. One of the alternative frequencies may be a sub-multiple of mains frequency.

A zero-crossing detector may be used to synchronise switching of the means for operating the switching circuit to zero crossing of the mains.

Where an inverter is used, it may be a high frequency inverter. It may have a frequency of operation of at least 10 kHz, and preferably less than 100 kHz. A voltage supply to a high frequency inverter may be unsmoothed DC derived from the mains.

The means for operating the switching circuit may comprise logic circuitry and the operating circuit may have a power supply for powering the logic circuitry. The power supply may have a reference node that is isolated from earth.

The logic circuitry may comprise a first microcontroller. The first microcontroller may be responsive to control elements to cause different operating states to occur.

Where an inverter is used, it may consist of a centre-tapped transformer, supplied at the centre tap with unsmoothed DC from the mains. There may be an inverter drive circuitry comprising FETs connected to the ends of the centre-tapped winding to push-pull switch the winding. There may be inverter drive circuitry that comprises a second microcontroller providing a constant frequency output.

The second microcontroller may be connected to be activated by the first microcontroller to drive the inverter. The second microcontroller may have an output to power the control elements. The second microcontroller may be configured so as to deactivate the output to power the control elements when it is activated to drive the inverter.

In a second aspect there is disclosed a circuit for selectively scattering and clearing a liquid crystal device comprising an operating circuit according to the first aspect.

The liquid crystal device may consist of a SmA material. The liquid crystal device may be a panel, all of which is to be cleared or scattered. The liquid crystal device may have plural areas that are to be cleared or scattered independently of one another. The liquid crystal device may be included in a display device. Output circuitry may be provided for each of the plural areas.

The liquid crystal device may be of a type that is scattered by a low frequency voltage wave, for example, mains frequency. The liquid crystal device may be of a type that is cleared by application of a higher frequency voltage wave, for example, a frequency of greater than 500 Hz. The clearing frequency may be between 800 Hz and 2500 Hz.

The first microcontroller may be configured to operate the switching circuit to provide a predetermined number of low frequency voltage waves to the liquid crystal device.

The first microcontroller may be configured to operate the switching circuit to provide a predetermined number of higher frequency voltage waves to the liquid crystal device.

The operating circuit may instead respond to a first input to provide low frequency voltage waves to the liquid crystal device, and to a second input to provide higher frequency voltage waves to the liquid crystal device. A human-operated control device may be capable of providing the first input in response to a given stimulus—e.g. pressing a first button; and the second input in response to a different stimulus, e.g. pressing a second button. The human operated control device may be a remote controller.

An embodiment uses full-wave rectified but unsmoothed DC derived e.g. from a mains transformer, or directly from the mains, or via a high-frequency isolating transformer chopping the mains waveform. To scatter the liquid crystal, low crossover of the mains waveform is detected, and the phase to the liquid crystal device is switched so that the liquid crystal has impressed on it a reconstituted mains-frequency sine wave. To clear the device, the phase of the voltage is switched back and forth providing a higher frequency waveform whose envelope follows the mains rectified sine wave but is chopped at the higher frequency. This greatly simplifies the power supplies, maintains DC balance, and obviates the requirement for high voltage electrolytic smoothing capacitors, thus increasing reliability.

In a third aspect there is disclosed a system for operating a liquid crystal device, the system comprising operating means configured to cause at least a portion of the device to change from a first state to a second state, a sensor associated with the portion of the liquid crystal device and a control means responsive to the output of the sensor to control the operating means.

The sensor may comprise a temperature sensor. The sensor may respond to brightness of light. The system may have a light source arranged to cause light to shine upon the liquid crystal device, and a sensor for determining a quantity of light. The quantity of light may be the amount of light passed by the liquid crystal device.

The operating means may be further configured to cause the portion of the device to change from the second state to the first state.

Embodiments can maintain DC balance, provide the necessary waveform frequencies, and a greatly simplified and more reliable power supply. Where a transformer is used, it can be over-rated as it need not operate continuously; and there is little distortion of the mains current waveform during the operation, i.e. power factor is near unity.

### BRIEF DESCRIPTION OF THE DRAWINGS

The accompanying drawings illustrate presently exemplary embodiments of the disclosure, and together with the general description given above and the detailed description of the embodiments given below, serve to explain, by way of example, the principles of the disclosure.

FIG. 1 shows a schematic drawing of a first embodiment of an operating circuit for a liquid crystal device;

FIG. 2 shows a block schematic drawing of a second embodiment of an operating circuit for a liquid crystal device;

FIGS. 3A and 3B show a schematic drawing of a third embodiment of an operating circuit for a liquid crystal device;

FIGS. 4A and 4B show waveforms at the output of the operating circuit of the third embodiment; and

FIG. 5 shows the driver circuit of FIG. 1 in greater detail.

### DETAILED DESCRIPTION

The following embodiments avoid the use of high capacitance capacitors, such as electrolytics. As will become apparent, embodiments may have no mains-frequency power transformers.

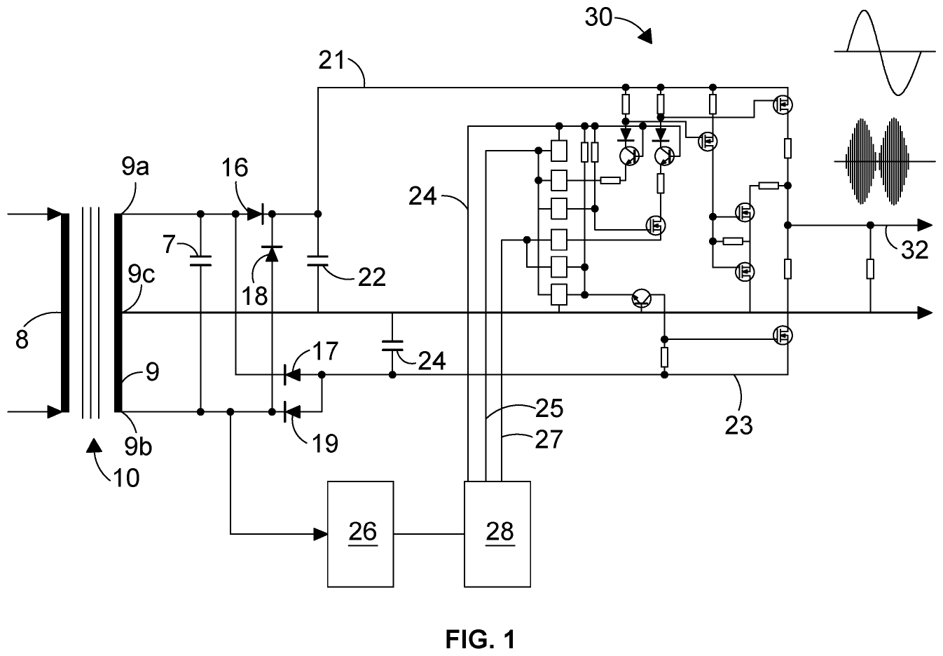

The embodiment of FIG. 1 is adapted for an SmA LC display using a passive matrix in which panel rows are driven with a drive voltage, which is a higher than the column data drive.

Referring to FIG. 1, a mains isolating transformer (10) has a primary winding (8) and a centre-tapped secondary winding (9) having first and second ends (9a, 9b) and a centre tap (9c). As known to those skilled in the art, mains frequency is normally one of two frequencies, specifically 50 Hz and 60 Hz, 50 Hz being common for example in Europe, and 60 Hz being often used in USA. The centre tap (9c) is connected to system earth (12). The first end (9a) of the output winding is connected to the anode of a first semiconductor rectifier diode (16) and the cathode of a second semiconductor rectifier diode (17). The second end (9b) is connected to the anode of a third semiconductor rectifier diode (18) and the cathode of a fourth semiconductor rectifier diode (19). The cathodes of the first rectifier diode (16) and the third rectifier diode (18) are connected in common to a first voltage supply rail (21). The anodes of the second rectifier diode (16) and of the fourth rectifier diode (18) are connected in common to a second voltage supply rail (23). The first and second ends (9a, 9b) of the transformer secondary winding are bridged by a first capacitor (7).

The first voltage supply rail (21) is connected to system earth via a first bypass capacitor (22) and the second voltage supply rail (23) is connected to system earth via a second bypass capacitor (24). The capacitors are sufficiently small not to allow the mains waveform to be distorted.

A zero-crossing detector (26) is connected, in this embodiment, to the secondary winding of the mains transformer (10) to supply a signal to a control device (28), the signal serving to indicate when the rectified mains voltage is near zero. The control device (28) is powered from the first voltage supply rail (21) and includes a power supply arrangement that provides a logic level supply (24), for example, 5 volts DC, for itself and for a driver circuit (30). It has a control input (29) and provides two control outputs (25, 27) forming first and second control inputs (25, 27) of the driver circuit (30), as will now be described.

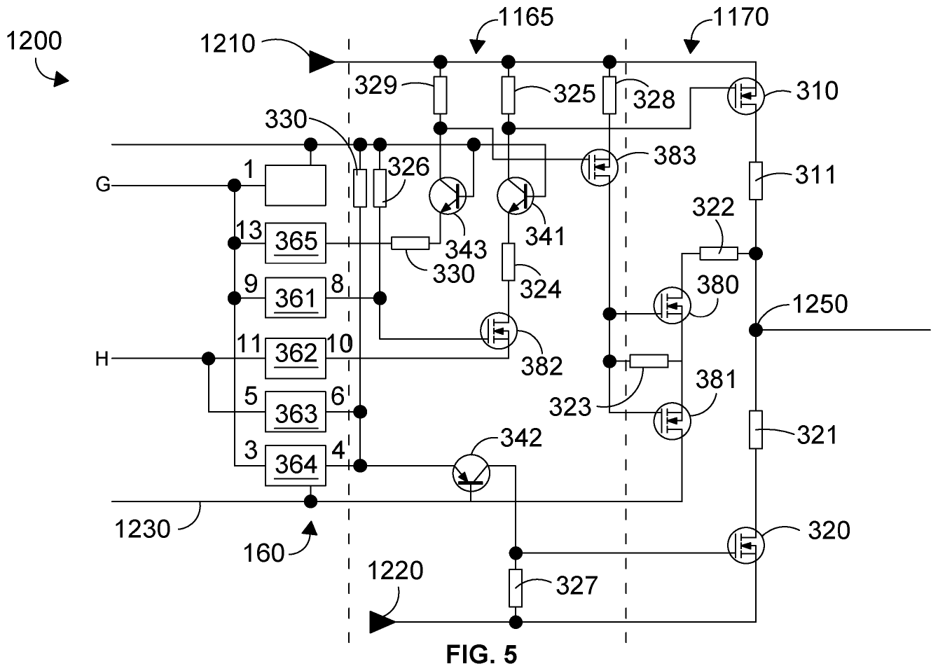

The driver circuit (30) is connected to drive an output supply node (32) with voltage/current from the first and second supply rails (21, 23). The driver circuit (30) is described further with regard to FIG. 5 herein. It has three output states: pull-up to the first supply rail (21); pull down to the second supply rail (23); and clamp to system earth (12). When the first input (25) is HIGH, the output node (32) is clamped to system earth (12) irrespective of the state of the second input (27). When the first input (25) is LOW, changes of state of the second input (27) switch the output node between the instantaneous values of the first and second supply rails (21, 23).

The internal circuitry of the control device (28) is not shown here. However, in an embodiment, when the control input (29) is floating, the first output (25) forming the first input (25) of the driver circuit (30) is HIGH. When the control input is at logic LOW, the first output/input (25) is at logic LOW, and the second input (27) is switched at a clearing frequency, with phase changeover at the instant of the zero-crossing of the rectified mains. When the control input (29) is at logic HIGH, the first output/input (25) is at logic LOW and the second output/input (27) is switched at the instant of the zero-crossing of the rectified mains. The clearing frequency is typically over 200 Hz and the upper frequency limit is determined by dissipation. Many practitioners in the field use a frequency in the range 500 hz-5 kHz. The present inventors have selected frequencies in the general area of 800 hz to 2.5 kHz for the particular formulation, and physical parameters of the panels they are using. Other practitioners use frequencies over 3 kHz.

When used with a liquid crystal of the type scattered upon application of a low frequency, scattering occurs when the control input (29) is HIGH, i.e. by the mains frequency sine wave being reconstituted by switching second input (27) at the correct zero-crossing time. To clear the liquid crystal, the mains frequency sine wave is chopped as shown to give a high frequency alternating square wave having the mains frequency envelope, again with the phase changing over at the zero crossing time.

It will be noted that the rectifier diodes (16-19) need to be sufficiently fast to pass the current pulses produced by the high frequency switching. The first capacitor (7) functions to provide a reservoir of charge for the high frequency switching.

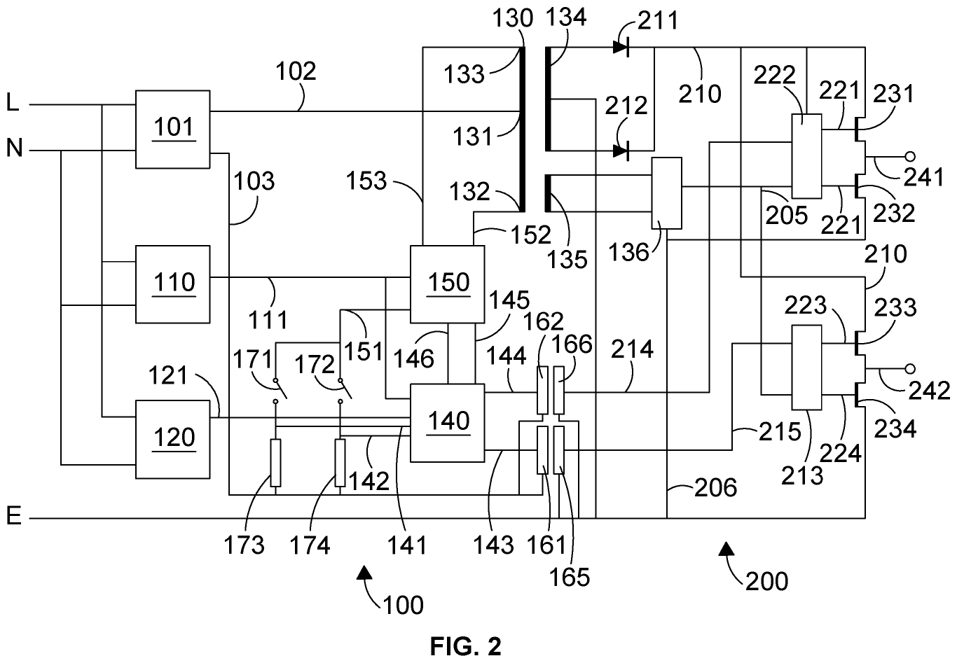

Referring to FIG. 2, a second embodiment eliminates the relatively heavy mains frequency transformer of the first embodiment. The second embodiment consists of two parts, a controlling part (100) and an output part (200). The controlling part receives a mains input having line (L) and neutral (N), and operates at a mains voltage reference, i.e. it is not earthed at all.

The L and N terminals connect to a full wave rectifier (101) having a positive output (102) and a negative output (103). The L and T terminals also connect to a low voltage supply (110) providing one or more low voltage outputs (111) that power other components of the controlling part (100) and to a zero-crossing detector (120), having an output (121). The positive output (102) goes to the centre tap (131) of the centre-tapped primary of a transformer (130).

The components of the controlling part (100) of this embodiment comprise a controller (140) and a driver (150). The controller receives the output (121) of the zero-crossing detector (120), and also has two controlling inputs (141, 142). It has first-fourth outputs (143, 144, 145, 146). The first output connects to the input side (161) of first opto-isolator (161; 165). The second output connects to the input side (162) of a second opto-isolator (162; 166). The third and fourth outputs connect to inputs (151, 152) of the driver (150). The driver has first-third outputs (151-153), of which the first (151) is connected to two switches (171, 172) connected to the controlling inputs (141,142) of the controller, respectively. The controlling inputs (141, 142) are pulled down to the negative output rail (103) via respective pull-down resistors (173, 174). The first output (151) has two states, an active state in which it supplies a supply voltage to the switches (171, 172) and an inactive state in which it is pulled down to the voltage on the negative output rail (103).

The second and third outputs (152,153) of the driver (150) connect to the respective ends (132, 133) of the primary windings of the transformer (130), thereby to form an inverter together with the secondary windings of the transformer (130).

The transformer (130) has first and second secondary windings (134, 135) of which the second (135) is used to provide drive for a local power supply (136), which outputs an earth-referenced voltage for the output part (200). In other words, the local power supply (136) has a first voltage output node (205) providing a supply, in one embodiment a logic level supply, for example, 5 volts; and a second output node (206) connected to system earth (E). The first secondary winding (134) is centre-tapped, the centre-tap also being connected to earth (E). The first secondary winding is connected to two diodes (211, 212), the diodes (211, 212) having their anodes connected to respective ends of the winding (134) and their cathodes connected in common to the output line (210). The output line (210) has an unsmoothed DC waveform on it. That is to say no smoothing capacitor is provided between the output line (210) and earth (E). In embodiments, the DC waveform has a voltage of between 100 and 180 volts. It is of course understood by those skilled in the art that it may be necessary to capacitively load the output line (210) or other rails or terminals for damping purposes.

The first power supply output node (205) supplies power to first (212) and second (213) control circuits. The first control circuit (212) has two outputs (221, 222). The first output (221) is connected to the gate of a first power FET (231) having its main current path, i.e. its drain-source path, connected at one end to the output line (210), and at the other end to a second power FET (232). The second output (222) is connected to the gate of the second power FET (232), whose main current path is connected between the first power FET (231) and earth (E). The first control circuit (212) is also connected to the output line (210).

The second control circuit (213) has two outputs (223, 224). The first output (223) is connected to the gate of a third power FET (233) having its main current path connected at one end to the output line (210), and at the other end to a fourth power FET (234). The second output (224) is connected to the gate of the fourth power FET (234), whose main current path is connected between the third power FET (233) and earth (E). The second control circuit (212) is also connected to the output line (210).

A first output node (241) is provided at the junction of the main current paths of the first and second power FETs; a second output node (242) is provided at the junction of the main current paths of the third and fourth power FETs.

The first-fourth power FETs form a bridge circuit that in use receives unsmoothed DC from the secondary windings (134) of the inverter transformer, and switches this to the output nodes (241,242) connected across the bridge diagonal.

The first control circuit (212) has a control input (214) connected to the output side (166) of the second opto-isolator (164); the second control circuit (213) has a control input (215) connected to the output side (165) of the first opto-isolator (160).

In operation, the incoming mains supply is full-wave rectified by the rectifier (101) and supplied to the inverter.

The zero-crossing detector (120) supplies a negative-going signal to the controller (140) at the mains sine waveform 0-volt crossover point. The power supply (110) supplies the driver (150) and the controller (140).

The controller (140) may be a microcontroller, or otherwise discrete circuitry, that controls the operation of the system. The driver (150) typically includes a microcontroller and power PETS driving the primary windings of the isolating transformer (130).

In quiescent mode, the driver (150) is inhibited; no drive signal is generated, and the output to the first and second switches (173, 174) is in the active state, thus enabling the switches.

When either of the switches is pressed, the controller (140) detects this.

In response to such detection, the controller (140) enables the driver (150). Enablement causes the driver to apply drive to the inverter, more specifically alternating the ends of the primary winding of the transformer (130) to the negative voltage rail (103). Enablement of the driver (130) at the same time disables the first and second switches (173, 174) by causing the driver to change the state of the first output (151) of the driver. Drive to the inverter causes it to operate at a predetermined frequency, in this embodiment, in the low frequency part of the RF spectrum (30 kHz-300 kHz, and typically between 50 kHz and 100 kHz).

Activation of the inverter causes both secondary windings (134, 135) to become powered, and this causes the second secondary winding (135) to apply power to the local power supply (136).

The controller (140) has a built-in delay, in this embodiment of about 200 ms, to allow the local power supply (136) to stabilise. After the delay, the controller (140) applies drive to the opto-isolators (160, 164) to operate the first and second control circuits (212, 213)

The controller (140) is set up so that if the first switch (171) is operated (SW2) the controller outputs switching signals at a desired and predefined switching rate so that the control circuits (212, 213) operate to cause the bridge circuit to correctly drive the output nodes (241, 242) at the required frequency

On the other hand, if the second switch (172) is operated, the controller (140) responds to the mains crossover signal from the zero-crossing detector (120), and switches the output in synchronism with the mains and at its frequency, for example, 50 or 60 Hz.

It is alternatively possible in other embodiments for the controller to operate at a lower frequency in response to operation of the second switch, for example, a sub-harmonic of the mains frequency.

In this embodiment, the output nodes (241, 242) are intended to be connected to a SmA liquid crystal panel, which may be fully cleared by switching the applied voltage at a panel clearing rate of around 2 kHz; hence the aforementioned desired switching rate is set to the panel clearing rate. Again, in this embodiment, a predetermined number of clearing cycles and a predetermined (probably different) number of scattering cycles is employed to fully clear and to fully scatter the material in the panel. These numbers are programmed into the controller (140), which counts the number of clear or scattering cycles, and upon reaching the relevant number stops the output drive, and disables the driver (150). Where full clearing or scattering is intended the number of cycles may exceed the exact number necessary.

Once the desired number of cycles has been applied, the controller (140) disables the driver (150). In response to this, the driver (150) turns off the inverter drive, then waits for a period of time, in this embodiment approx. 5-10 seconds, before enabling the first and second switches (173, 174).

It is possible that in some circumstances and applications, variations in ambient temperature, or variations in the temperature of the LC material due to operation of the panel containing it, may require different number of cycles to be employed. Where that occurs, a temperature sensor may be employed in concert, for example, with a lookup table, to control or vary the number of cycles applied.

In another embodiment, also for scattering or clearing SmA liquid crystal panels, the number of cycles is not programmed into the controller, which instead uses a sensor device as part of a feedback loop to control the scattering or clearing (or both). In a refinement, the panel has a light source and a sensor and these are used together to control at least one of scattering or clearing. The light source and sensor may be shielded to prevent daylight or other ambient light reaching the sensor. It has been found that dye-doping certain liquid crystal materials enhances their “contrast” between scattered and cleared states. The present disclosures will work well with dye-doped SmA material panels.

In yet another embodiment, the described circuit is modified so that plural different outputs can be provided. This enables more sophisticated devices than simple panels to be driven, for example, LC displays. An embodiment uses a matrix display.

In other arrangements, the isolating transformer (130) is not centre-tapped. In one such arrangement, it could be single winding bridge-driven and full wave rectified. In some embodiments, the controlling part and driving part are interconnected by a suitable double-insulated isolating transformer, which would avoid any need for the load to be earthed.

Turning to a more detailed third embodiment, similar to that described with reference to FIG. 2, once again a single LC panel can be driven with only a single supply rail. In this embodiment, two similar two-state drivers pull to ground or to the supply rail. This driver is intended for single panels, and uses two bipolar output stages switching between ground and a supply rail to generate a DC-balanced waveform. The supply rail is not a continuous supply, but has a quasi-full-wave rectified mains envelope, generated by an approx. 70 kHz inverter circuit transformed from mains to the correct peak voltage to drive the scatter panel.

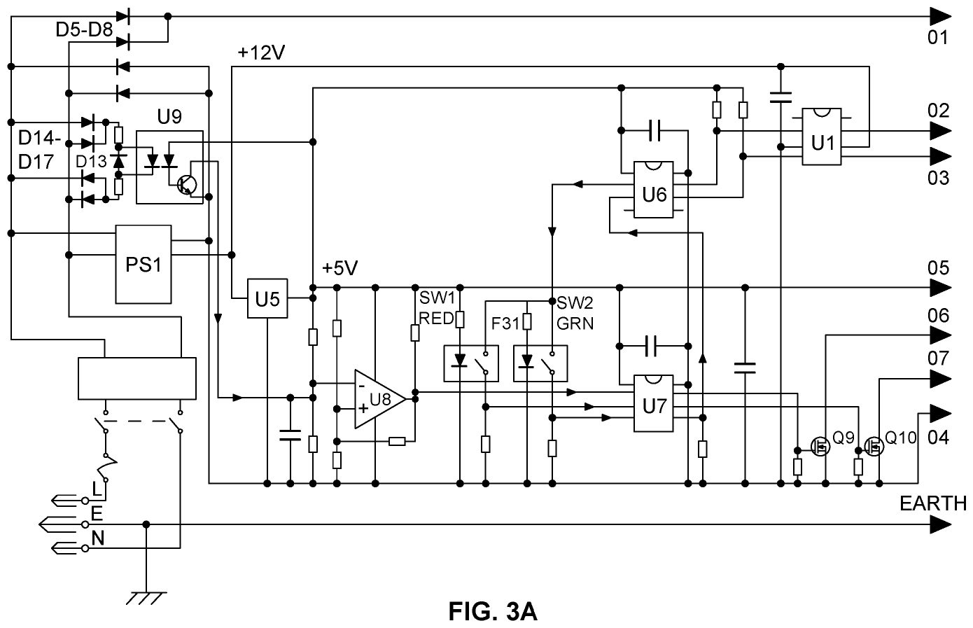

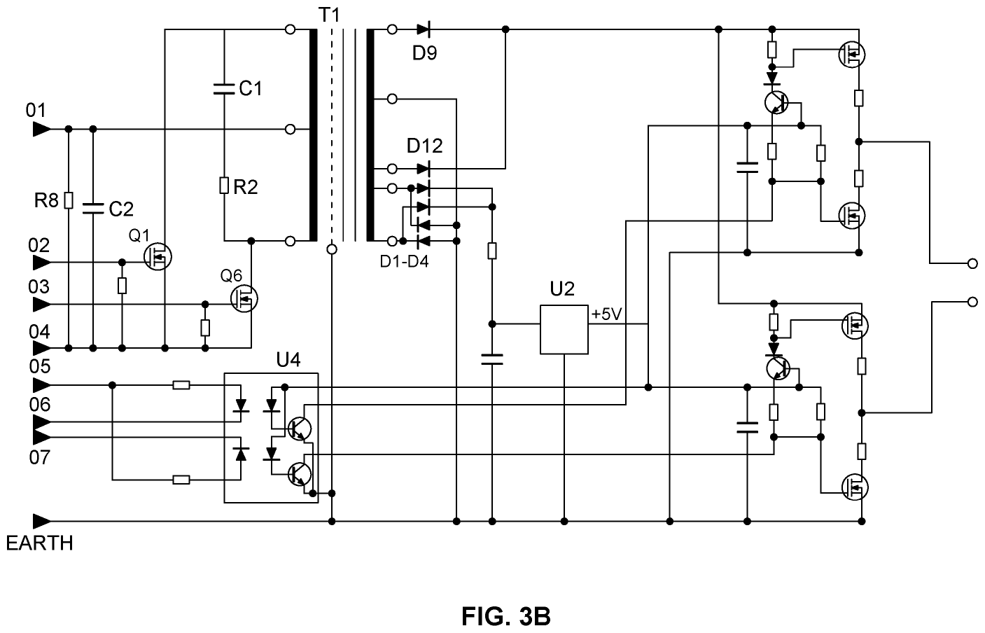

Referring to FIG. 3A, in the third embodiment, incoming mains is switched, fused and filtered, and full-wave rectified by D5-D8 and supplied to an inverter stage.

The assembly D14-17, the opto-isolator U9 and the Schmitt trigger U8 supply a negative-going signal to U7 at the mains sine waveform 0-volt crossover point. PSI supplies +12 volts to the driver chip U1, and U5 supplies +5 volts to the logic. The Red LED in SW1 is illuminated to show power is ON.

U7 is a PIC microcontroller that controls the operation of the system. U6 is an additional PIC microcontroller that drives the gates of the inverter transistors through the driver chip U1.

In quiescent mode, U6 is inhibited; no drive signal is generated, and the output to SWI and SW2 is HIGH, illuminating the Green “READY” LED in SW2, and enabling the switches.

When either of the switches is pressed, U7 detects this and sets up the following events:

1/ U6 is enabled; this applies drive to the inverter, and disables the switches and turns off the Green LED.

2/ A delay of about 200 ms ensues to allow the logic supply in the mains isolated section of FIG. 3A to stabilise.

3/ After the approx. 200 ms delay, U7 applies drive to the transistors Q9 and Q10, to drive the output to the panel.

If the Clear switch is pressed (SW2), an approx. 2 kHz switching rate is provided.

If the Scatter switch is pressed (SW1), U7 detects the mains crossover signal, and switches the output

4/ U7 counts the number of clear or scattering cycles, stops the output drive, and disables the inverter driver U6.

5/ U6 turns off the inverter drive, then waits approx. 5-10 seconds before enabling the switches again and illuminating the Green “Ready” LED.

Referring to FIG. 3B, Q1 and Q8 are 1 kV MOSFETS which drive the isolating transformer T1. C1 and R2 may be required in some embodiments to damp ringing. C2 is typically 1 μF, and is a protective device serving to sink return current from the transformer under low load; otherwise the voltage rises during part of the switching cycle, giving an output overvoltage. This could possibly destroy the MOSFETs Q1 and Q8. C2 also therefore acts as a reservoir capacitor at low load, peak-rectifying the AC mains when the drive is absent, and distorting the classic rectified sine-wave waveform at intermediate loads. This has no detrimental effect on the LC panel, since by switching at the AC mains crossover point, the waveform maintains its DC balance.

R8 is a bleed resistor having a resistance of about 200K serving under zero-drive conditions to bleed a small amount of current through the rectifier diodes, otherwise the rectified voltage can rise when off-load to the peak-to-peak value of the input mains. When operation of the inverter stops, the capacitor C2 remains charged. However, when the supply is discontinued R8 discharges residual charge from the parallel capacitor C2.

Once the inverter drive is running, the waveform at the cathodes of D9, D12 follows that at the input 01, at around half the input voltage. D1-D4 and U2 supply +5 v for the opto-isolators U4 and the output stages.

Transformer T1 and opto-isolator U4 isolate the output stage from the live mains circuitry to 4 mms creepage distance and tested to 1 kV isolation. The output section is connected to mains earth, and as such the driver MUST be earthed; it is not intended or designed for double-insulation (i.e. non-earthed) operation. However, both sides of the panel are driven so neither side can be considered grounded. There is, however, no direct connection to the mains. A suitably designed transformer meeting double insulation requirements could also be used, with no earthed connection.

Immediately after the start of the inverter drive, the output voltage of D9, D12 rapidly rises. The charge coupled to the gates of Q2 and Q4 briefly turns these transistors on, causing a short voltage spike at the output, before this is quenched by the establishment of the output +5 v supply from U2. Since both outputs spike simultaneously, this does not inject charge into the panel, and does not have any DC unbalancing effect.

The envelope of the drive waveform to the panel depends on the panel loading, and will have the same outline as the rectified mains at D5-D8. This will not be a half-sine wave but will have an irregular but DC-balanced outline.

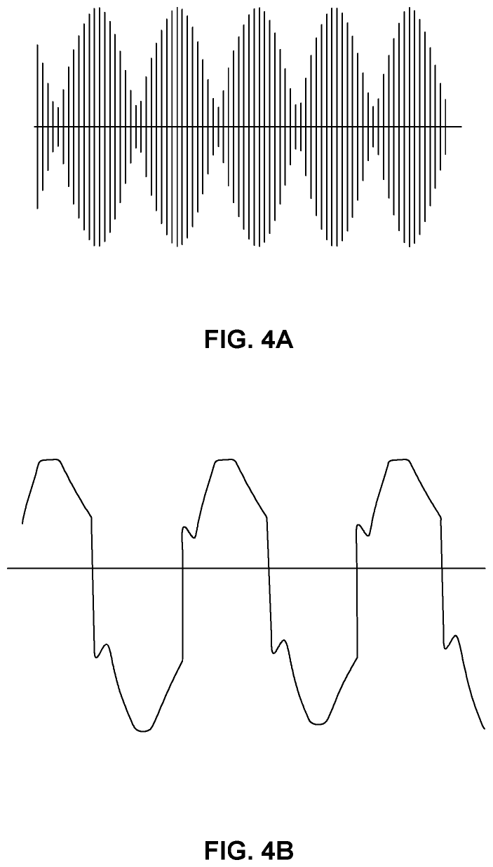

FIG. 4 shows the voltage output of the operating circuit when applied to an SmA LC panel. FIG. 4a shows the clearing waveform, specifically the mains frequency “chopped” at high frequency and FIG. 4b shows the scattering waveform, being the mains frequency “unchopped”, i.e. 50 Hz or respectively 60 Hz.

Referring to FIG. 4a, the SmA panel provides a higher load, i.e. a lower impedance, at the higher frequency and it will be seen that the amplitude follows the mains cycle.

Referring to FIG. 4b, the scattering waveform interacts with the panel to load the psu less, so the rectified mains only decays in the 1 μF bypass capacitor to about half amplitude while on load when the input mains zero-crosses; then as the input sine wave rises, it catches up with the decaying voltage.

Further embodiments have no transformers but use direct mains connection to rectifiers to provide unsmoothed or substantially unsmoothed DC.

Referring to FIG. 5, a driver circuit (1200) for a liquid crystal device has a positive supply rail (1210), a negative supply rail (1220), a ground rail (1230), and an output node (1250). It consists of three parts, a logic part (1160), a control part (1165) and a power part (1170). The driver circuit (1200) is powered by a power supply circuit. Significantly, the logic part and control part are powered by a logic-level power supply (here 5 volts is chosen), and the circuit is configured so that this constant level supply ensures sufficient drive to the components of the power part. The device is generally capacitive in nature; however, there is also an ion current to supply during the scattering process and this is also quite substantial. The driver has to supply this during the ion transfer in the excursions of the low frequency waveform. Especially where it is large in size it may draw a relatively heavy current when initially supplied with positive or negative-going power, and this needs to be taken into account. For example, without sufficient drive to the power part (1170), under-driven power devices in the power part might cause the output levels to diverge from the voltages on the respective power rails.

In driving a panel containing a composition having Smectic-A liquid crystal properties it is important to provide DC balance. The present embodiment provides square wave drive, and symmetrical waveform. DC balancing can be maintained by starting and stopping the waveform at a zero-crossing point and including an integral number of cycles.

It should of course be understood that, for example, mark-space control of rectangular waves is envisaged, as opposed to square waves. In yet other arrangements, other wave shapes, for example, sine wave drive may be employed.

It is important that, when addressing electrodes, the unselected electrodes be positively grounded.

However, grounding unselected rows means that all pixels in those rows will be subject to a column voltage of either the pixel select waveform or the pixel unselect waveform (in this case both having an amplitude excursion from +50 volts to −50 volts), which is referred to in the art as the “error voltage”. Certain compositions discussed in this specification have a high error voltage tolerance; that is pixels will withstand a high error voltage without being affected by it. The ability to withstand a high error voltage means that the “one-third select” regime can be used successfully. However, other drive arrangements may be used with those compositions, for example, those in which a lower voltage or higher voltage is applied across unselected rows than a voltage of one third of the voltage used to clear the selected pixels.

A reason for grounding unselected rows (or respectively columns) is that voltages capacitively-coupled, e.g. from adjacent row/column electrodes, cannot arise in the unselected electrodes. Such voltages, if they did arise, could exceed the threshold voltage of the composition and thereby affect pixels that were to be left unaltered. When no waveform is applied it is good practice to ground all rows and columns to improve lifetime. Any waveform generator, either for pixelated displays or unpixelated large panels, has to be able to drive an alternating positive and negative voltage across the liquid crystal cell, and also clamp both sides to the same voltage, in this embodiment, but not necessarily, to ground (0 volts). Drive ends after an integral number of waveform cycles, and generators connect to ground in absence of drive requirements

The power part (1170) has a first p-channel power MOSFET (310) with one end (source) of its main conduction path connected to the positive rail (1210), and the other end (drain) of its main conduction path connected via a first resistor (311) to the output node (1250). A first n-channel power MOSFET (320) has one end (source) of its main conduction path connected to the negative rail (1220) and the other end (drain) of its main conduction path connected via a second resistor (321) to the output node (1250). A bilateral n-channel power MOSFET pair (380, 381) has one end (one drain) of their main current path connected to the ground rail (1230) and the other end (the other drain) connected via a third resistor (322) to the output node (1250). The bilateral pair is provided as a pair of transistors, connected back to back to ensure DC isolation against both positive and negative output node voltages. The inherent diode in the transistor structure would pass positive or negative output voltages to ground if only a single transistor were used. A fourth resistor (323) connects the common gates of the pair to the common source connection.

In the control part (1165), the gate of the first p-channel MOSFET (310) is connected to the positive rail via a first pull-up resistor (325), and to the collector of a first common-base pull-down npn bipolar transistor (341), whose base is connected to a logic power supply rail (1260), here a 5 volt rail, and whose emitter is connected via a fifth resistor (324) to the drain of a first p-channel switching FET (382). The gate of the first p-channel switching FET (382) is connected to the logic power supply rail (1260) via a second pull-up resistor (326). The gate of the first n-channel power MOSFET (320) is connected via a pull-down resistor (327) to the negative rail (1220), and to the collector of a common-base pull-up pnp bipolar transistor (342). The gate of the common-base pull-up pnp bipolar transistor (342) is connected to the ground rail (1230), and the emitter of the common-base pull-up pnp bipolar transistor (342) is connected via a third pull-up resistor (330) to the logic power supply rail (1260). The common gates of the bilateral pair (380,381) are connected to the drain of a p-channel switching FET (383), whose source is connected to the positive rail (1210) via a source resistor (328). The gate of the p-channel switching FET (383) is connected via a second pull-up resistor (329) to the positive supply rail (1210) and to the collector of a second common-base pnp pull-down transistor (343), whose base is coupled to the logic power supply rail (1260), and whose emitter leads to one end of a sixth resistor (330).

In the logic part (1160), three open-collector inverters are controlled by a first control signal at a first node (G) and two by a second control signal at a second node (H). A first open-collector inverter (361), connected to the first node (G), has its open-collector output node coupled to the gate of the first p-channel switching FET (382). The source of the first p-channel switching FET (382) is connected to the open-collector of the second open-collector inverter (362), which has its input connected to the second node (H). The second node (H) also controls a third open-collector inverter (363), whose output is coupled to the emitter of the common-base pull-up npn bipolar transistor (342).

The fourth open-collector inverter (364) is controlled by the first node (G), and its output is also coupled to the emitter of the common-base pull-up npn bipolar transistor (342). The fifth open-collector inverter (365) is also controlled by the first node (G) and its output is connected to the other end of the sixth resistor (330).

The circuit is thus fully DC-coupled, and need not include capacitors. All the control part is referenced only to the logic supply rail (1260) and the ground rail (1230).

In use, when first node (G) is low, the outputs of the first and fourth open-collector inverters (361, 364) are open-circuit. Hence the gate of the first p-channel switching FET (382) turns it on. Then second node (H) goes high, which causes the output of the second open-collector inverter (362) to go low, so that the first p-channel switching FET (382) conducts. This pulls the emitter of the first common-base pull-down npn bipolar transistor (341) low, turning that transistor on. This in turn pulls down the gate of the first p-channel power MOSFET (310), turning it on, and connecting the output node (1250) to the positive supply rail (1210). Since the drive current is set by the control part without reference to the positive or negative rails, the circuit can be, and is dimensioned so that the pull-down current via fifth resistor (324) causes a specific voltage, in this embodiment approx. 10 v, across first pull-up resistor (325), so that the drive to the first p-channel power MOSFET (310) is independent of the voltage on rail (1210), providing this voltage is above a low threshold (of approx. 15 volts).

If first node (G) is low and second node (H) goes low, the first pull-up resistor (325) pulls up the gate of the first p-channel power MOSFET (311), thereby turning it off. Both the third and fourth open-collector inverters (363, 364) have open-circuit outputs and hence third pull-up resistor (330) turns on the common base pull-up npn transistor (342), which sinks current through pull-down resistor (327). Since the current is determined again only by the control part, this causes a drive voltage to the first n-channel power MOSFET (320) that is independent of the supply rail voltage, and the first n-channel power MOSFET (320) is turned on to connect the negative rail (1230) to the output node.

Regardless of the state of the second node (H), if the first node (G) goes high, the common base pull-up npn transistor (342) is cut off by the fourth open-collector inverter (364) output going to earth. This turns off first n-channel power MOSFET (321). The first p-channel switching FET (382) is turned off by the open-collector inverter (361) output going to earth, and this in turn ensures the first p-channel power MOSFET (310) is turned off.

The fifth open-collector inverter (365) output goes low, and this causes second common-base pnp pull-down transistor (343) to turn on, which in turn causes p-channel switching FET (383) to draw current via source resistor (328), to provide current to fourth resistor (322), thereby turning on the bilateral pair (380,381). This means the bilateral pair will sink charge from the output node to earth regardless of the polarity of the output node.

The devices described may be applied to liquid crystal panels or displays, and are especially suitable for SmA material-containing panels and displays. In such devices, as noted above, dye-doping may be used. The specific materials used are wide-ranging, and include organic and siloxane-based materials, inter alia.

Some of the embodiments use TTL logic, and therefore operate using 5 volt rails. Use of other logic types and indeed of discrete components is also envisaged. The embodiments that have been described provide a first signal at mains frequency and a second higher frequency. Other embodiments may provide a first frequency at a sub-harmonic of mains frequency and a second different frequency, or may be controlled to provide more than two frequencies.

The invention is not restricted to the described embodiments but rather extends to the scope of the appended claims.

1. A circuit for operating a liquid crystal device, the circuit having means for supplying unsmoothed DC from an AC source to a switching circuit, wherein the switching circuit has an output, and means for operating the switching circuit to provide at least two alternative frequencies at the output.

2. The circuit according to claim 1, wherein the switching circuit is a bridge circuit having a pair of output terminals forming the output.

3. The circuit according to claim 1, wherein the means for supplying unsmoothed DC comprises an inverter

4. The circuit according to claim 1, wherein the unsmoothed DC is derived from a mains transformer, so that the ripple rate is 50 or 60 Hz, or 100 or 120 Hz.

5. The circuit according to claim 1, having a zero-crossing detector and configured to synchronise switching of the means for operating the switching circuit to zero crossing of the mains.

6. The circuit according to claim 1, wherein the means for operating the switching circuit comprises logic circuitry.

7. The circuit according to claim 1, wherein the means for operating the switching circuitry is responsive to control elements to cause different operating states to occur.

8. A circuit for selectively scattering and clearing a liquid crystal panel comprising a SmA material, the circuit comprising an operating circuit according to claim 1.

9. A system for operating a liquid crystal device, the system comprising operating means configured to cause at least a portion of the liquid crystal device to change from a first state to a second state, a sensor associated with the portion of the liquid crystal device and a control means responsive to the output of the sensor to control the operating means, wherein the operating means comprises an operating circuit according to claim 1.
